(19) United States
(12) Patent Application Publication
(10) Pub. No.: US 2008/0095574 A1
(43) Pub. Date: Apr. 24, 2008

(54) QUICK CONNECTOR MODULE WITH AN UNPLUGGING SAFETY DEVICE

(76) Inventors: Pi-Chen CHANG, Changhua Hsien (TW); Yung-Pin Chang, Changhua Hsien (TW)

Correspondence Address: LEONG C LEI, PMB # 1008, 1867 YGNACIO VALLEY ROAD, WALNUT CREEK, CA, 94598, US

(21) Appl. No.: 11/626,386

(22) Filed: Jan. 24, 2007

(30) Foreign Application Priority Data
Oct. 18, 2006 (TW) 095218378

(51) Int. Cl. B25G 3/00

(52) U.S. Cl. 403/232.1

(57) ABSTRACT

A quick connector module for a safety device is disclosed. The connector module comprises a male connector, a female connector, an unplugging safety body and an elastic clip, characterized in that the unplugging body has one end vertically bent to form into a positioning ring, and has the other end is a lifting lug which is bent upward to form a tying strap, and the roof section of the lifting lug which curved out from the unplugging safety body is provided with a combination hole for the engagement of the elastic clip which is then fitted a combination rim at the front end of the female connector, a securing rim mounted at the unplugging safety body is fitted to the securing point at the protruded neck of the unplugging safety body is fitted to the securing point at the protruded neck of the quick connector, and the combination hole after being mounted with the elastic clip, the combination rim of the female connector is combined and the lifting lug is used for the fastening of the elastic clip upon its separation from the combination rim.

### BACKGROUND OF THE INVENTION

(a) Technical Field of the Invention

The present invention relates to a quick connector module, and in particular, a positioning rim having an unplugging safety device being secured onto a positioning point on the quick make connector.

(b) Description of the Prior Art

Quick connector facilitates connection or disconnection of conduits used for fluid, for instance, useful in air pressure brake of trailers and trucks or pneumatic loops for pneumatic tools, or low oil hydraulic loop.

Due to the fact that the performance of quick connector in disconnection is good by using a single hand to unplug the mounting rim connected to the quick male connector from the female connector, the male connector can be rapidly separated from the female connector, such that the instant disconnection of the male connector from the female connector, the residual air pressure will be rapidly ejected out which will blow upward the male connector if the hand does not hold tight to the male connector. Very often, the user uses one hand to hold the quick male connector, he may not aware of the male connector and thus the male connector may accidentally hurt someone or the user around the male connector. Accordingly, it is an object of the present invention to provide a quick connector module with an unplugging safety device which mitigates the above drawbacks.

### SUMMARY OF THE INVENTION

The primary purpose of the present invention is to provide a quick connector module for a safety device comprising a male connector, a female connector, an unplugging safety body and an elastic clip, characterized in that the unplugging body has one end vertically bent to form into a positioning ring, and has the other end is a lifting lug which is bent upward to form a tying strap, and the roof section of the lifting lug which curved out from the unplugging safety body is provided with a combination hole for the engagement of the elastic clip which is then fitted a combination rim at the front end of the female connector, a securing rim mounted at the unplugging safety body is fitted to the securing point at the protruded neck of the quick connector, and the combination hole after being mounted with the elastic clip, the combination rim of the female connector is combed and the lifting lug is used for the fastening of the elastic clip upon its separation form the combination rim.

Yet still another object of the present invention is to provide a quick connector module with an unplugging safety device, wherein the male connector is rapidly unplugged from the female connector but is still tied to the unplugged safety body and the male connector can be rapidly re-connected to another loop of the female connector.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of the quick connector module in accordance with the present invention.

FIG. 2 shows perspective view of the quick connector module, the male connector being plugged with the female connector, in accordance with the present invention.

FIG. 3 is a perspective view showing the detachment of the male connector from the female connector of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

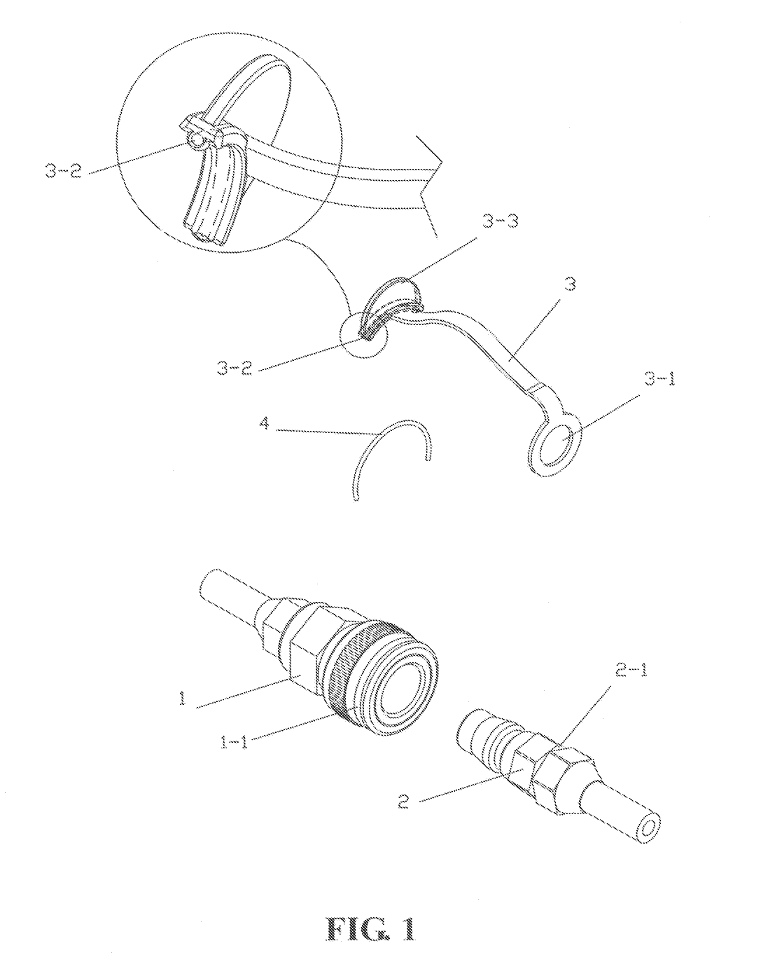

Referring to FIG. 1, which is an exploded perspective view of the quick connector module with an unplugging safety device of the present invention. The connector module comprises a quick male connector 2, a quick female connector 1, an unplugging safety body 3 and an arch-shaped elastic clip 4. The safety body 3 has one end hanging down and being bent to form a positioning rim 3-1. Another end of the safety body 3 is a lifting lug 3-3 with a tying strap, and the safety body 3 is bent out from the root section of the lifting lug 3-3 and passing through a combination hole 3-2 of the elastic clip 4, and after that the head end of the female connector 1 is a combination rim 1-1.

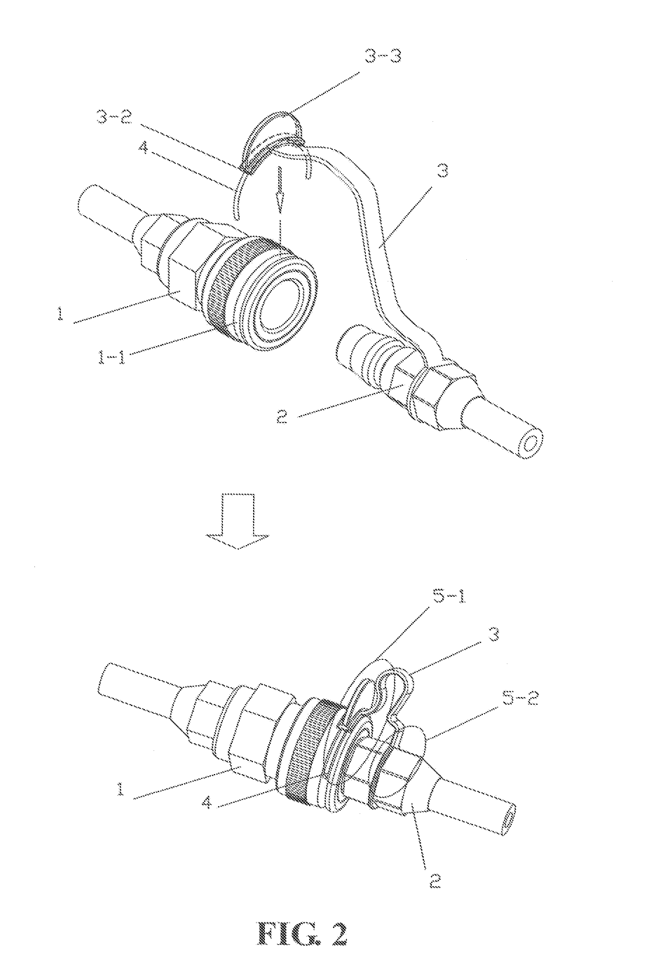

In combination, as shown in FIG. 2, the positioning rim 3-1 is mounted at a positioning point 5-2 of the male connector 2, for instance, as shown in 5-2 of the figure. The combination hole 3-2 is inserted into the combination hole 3-2 of the elastic clip 4, and the lifting lug 3-3 is squeezed and is pressed into the combination rim 1-1 of the female connector 1, as shown in the figure, the circled combination section 5-1. The entire combination will not affect the function of the male connector 2 to be inserted into the female connector 1.

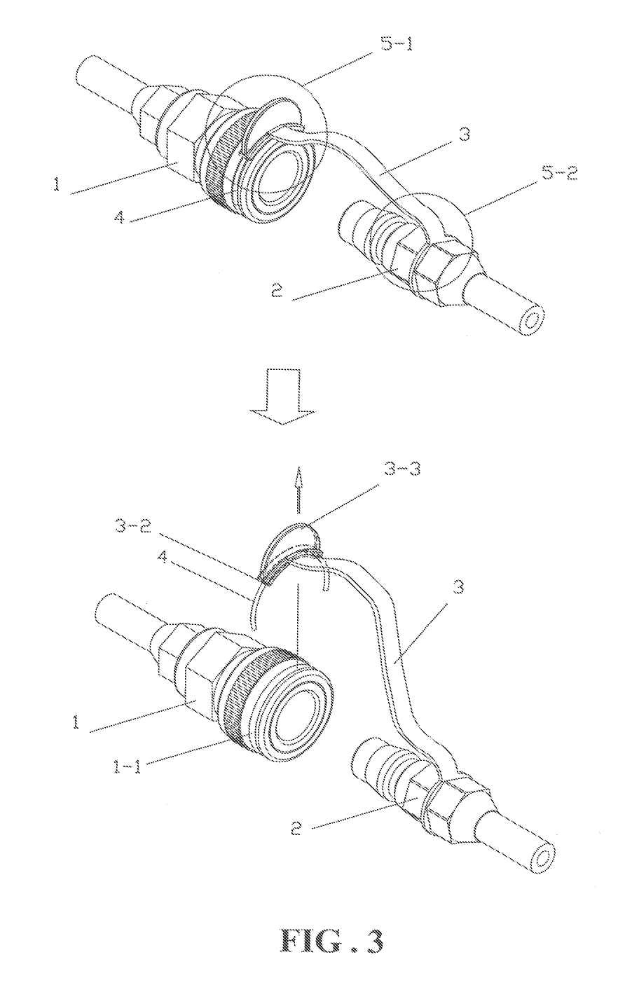

When the male connector 2 is to be unplugged, as shown in FIG. 3, which show the separation of the female connector 1 from the male connector 2. When the male connector 2 is unplugged, the safety body 3 still ties the female connector 1 and the male connector 2 such that the male connector 2 will not hurt someone around when the male connector 2 is released from the female connector 1, and following the safety body 3, the male connector 2 is accessible, and only when the lifting lug 3-3 is lifted, the elastic clip 4 will disengage with the combination rim 1-1, and this will allow the female connector 1 to fully disconnect with the male connector for use in insertion on other loops. The elastic force of the elastic clip 4, is positioned in such a way that it could support the weight of the male connector 2, and that application of a slight force, the lifting lug 3-3 if lifted. That is lifting will cause the formation of an opening which will not out off the function of quick connection.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made be those skilled in the art without departing in any way from the spirit of the present invention.

I claim:

1. A quick connector module for a safety device comprising a male connector, a female connector, an unplugging safety body and an elastic clip, characterized in that the unplugging body has one end vertically bent to form into a positioning ring, and has the other end is a lifting lug which is bent upward to form a tying strap, and the roof section of the lifting lug which curved out from the unplugging safety body is provided with a combination hole for the engagement of the elastic clip which is then fitted a combination rim at the front end of the female connector, a securing rim mounted at the unplugging safety body is fitted to the securing point at the protruded neck of the quick connector, and the combination hole after being mounted with the elastic clip, the combination rim of the female connector is combined and the lifting lug is used for the fastening of the elastic clip upon its separation from the combination rim.
